(19) United States
(12) Patent Application Publication
(10) Pub. No.: US 2015/0317011 A1
(43) Pub. Date: Nov. 5, 2015

(54) TOUCH PANEL AND TOUCH DISPLAY DEVICE

(71) Applicant: InnoLux Corporation, Miao-Li County (TW)

(72) Inventors: Ya-Ling CHEN, Miao-Li County (TW); Wei-Ting HSU, Miao-Li County (TW); Guang-Ying ZENG, Miao-Li County (TW); Chih-Chang CHEN, Miao-Li County (TW); Ping-Hsu CHENG, Miao-Li County (TW); Chuan-Chi CHIEN, Miao-Li County (TW)

(21) Appl. No.: 14/682,513

(22) Filed: Apr. 9, 2015

(30) Foreign Application Priority Data
Apr. 30, 2014 (TW) 103115485

(51) Int. Cl. G06F 3/044

(52) U.S. Cl. CPC G06F 3/044

(57) ABSTRACT

An embodiment of the invention provides a touch panel including: a substrate having a touch region and a peripheral region surrounding the touch region; a touch electrode pattern disposed in the touch region; and a ground ring disposed in the peripheral region and surrounding the touch region, and the ground ring electrically connected to a capacitor device.

### CROSS REFERENCE TO RELATED APPLICATIONS

This Application claims priority of Taiwan Patent Application No. 103115485, filed on Apr. 30, 2014, the entirety of which is incorporated by reference herein.

### BACKGROUND OF THE INVENTION

1. Field of the Invention

The present invention relates to a touch panel, and in particular relates to a touch panel and a touch display device with a ground ring.

2. Description of the Related Art

The touch panel is applied in point of sales (POS) systems, arcade games, handheld electronic products, etc. The POS systems are common in outlet stores, department stores, restaurants, etc.

Since electrostatic discharge occurs in the atmospheric environment, electrostatic charges may easily accumulate in the touch panel. Electrostatic charges may result in problems in the touch panel. Take the POS systems as an example; if there is an accumulated electrostatic charge in the touch panel, the mean time between failures (MTBF) of the touch panel may be reduced, resulting in premature aging. These electrostatic charges can easily cause the system to crash. Electrostatic charges may increase the risk of data loss.

Therefore, the problem of the accumulation of electrostatic charges in touch panels on the market needs to be solved.

### BRIEF SUMMARY OF THE INVENTION

An embodiment of the invention provides a touch panel including: a substrate having a touch region and a peripheral region surrounding the touch region; a touch electrode pattern disposed in the touch region; and a ground ring disposed in the peripheral region and surrounding the touch region, and the ground ring is electrically connected to a capacitor device.

An embodiment of the invention provides a touch display device including: a display panel; and a touch panel disposed on the display panel, wherein the touch panel includes: a substrate having a touch region and a peripheral region surrounding the touch region; a touch electrode pattern disposed in the touch region; and a ground ring disposed in the peripheral region and surrounding the touch region, and the ground ring is electrically connected to a capacitor device.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a top view of a touch panel of an embodiment of the present invention;

FIG. 2A is an enlarged view of the structure in the region A of FIG. 1;

FIG. 2B is a cross-sectional view of the structure along sectional line I-I′ in FIG. 2A;

FIG. 3 is a top view of a touch panel of an embodiment of the present invention;

FIG. 4A is an enlarged view of the structure in the region A of FIG. 3;

FIG. 4B is a cross-sectional view of the structure along sectional line I-I′ in FIG. 4A; and

FIG. 5 is a cross-sectional view of a touch display device of an embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

It should be understood that the following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numbers and/or letters in the various examples. This repetition is for the purpose of simplicity and clarity and does not in itself dictate a relationship between the various embodiments and/or configurations discussed. Furthermore, descriptions of a first layer “on,” “overlying,” (and like descriptions) a second layer, include embodiments where the first and second layers are in direct contact and those where one or more layers are interposing the first and second layers.

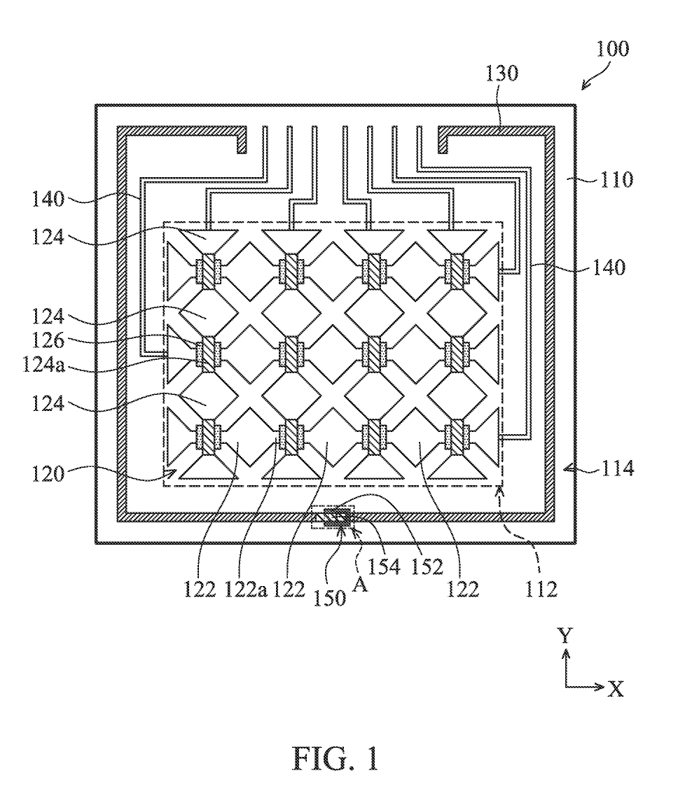

FIG. 1 is a top view of a touch panel of an embodiment of the present invention. Referring to FIG. 1, a touch panel 100 of the present embodiment includes a substrate 110, a touch electrode pattern 120, and a ground ring 130. The substrate 110 may have a touch region 112 and a peripheral region 114. The peripheral region 114 surrounds the touch region 112. The substrate 110 includes, for example, a glass material or a polymer material. For example, the substrate 110 includes polyethylene terephthalate (PET), polyethersulfone (PES), polyacrylate (PAR), poly(ethylene 2,6-naphthalate) (PEN), polyphenylene sulfide (PPS), polyallylate, polycarbonate (PC), or the like. The substrate 110 may be a rigid substrate or a flexible substrate. The substrate 110 may have a plane surface shape, a curved surface shape, or another suitable shape.

The touch electrode pattern 120 is disposed in the touch region 112. In one embodiment, the touch electrode pattern 120 includes first touch electrodes 122 arranged in an X-axis direction, connecting portions 122a, second touch electrodes 124 arranged in a Y-axis direction, bridge portions 124a, and an insulating layer 126. The connecting portion 122a is connected to two adjacent first touch electrodes 122. The bridge portion 124a is connected to two adjacent second touch electrodes 124. The insulating layer 126 is located between the connecting portions 122a and the bridge portions 124a to electrically insulate the connecting portions 122a from the bridge portions 124a. In other embodiments (not shown), the touch electrode pattern 120 is another kind of touch electrode pattern. For example, the touch electrode pattern is a touch electrode pattern having touch electrodes only arranged in an X-axis direction, a touch electrode pattern having touch electrodes only arranged in a Y-axis direction, or a touch electrode pattern having touch electrodes coplanar with each other. Each of the touch coplanar electrodes is connected to one corresponding signal line.

The first touch electrodes 122, the connecting portions 122a, and the second touch electrodes 124 include indium tin oxide (ITO), indium zinc oxide (IZO), or another suitable transparent conductive material. The bridge portions 124a include, for example, metal (e.g., silver or aluminum), transparent conductive materials (e.g., ITO), or other materials with good conductive properties.

The touch panel 100 may include signal lines 140. The signal lines 140 are disposed on the substrate 110 and in the peripheral region 114. Each of the signal lines 140 has an end connected to the first touch electrodes 122 or the second touch electrodes 124. Each of the signal lines 140 has another end extending to a side of the touch region 112 so as to connect with a flexible circuit board in a subsequent process. The signal lines 140 are insulated from each other. The signal lines 140 include metal (e.g., silver or aluminum), transparent conductive materials (e.g., ITO), or combinations thereof

The ground ring 130 of the present embodiment is disposed in the peripheral region 114 and surrounds the touch region 112. The ground ring 130 is electrically connected to a capacitor device 150. For example, the ground ring 130 is electrically connected in series with the capacitor device 150. The ground ring 130 includes metal (e.g., silver or aluminum), transparent conductive materials (e.g., ITO), or combinations thereof

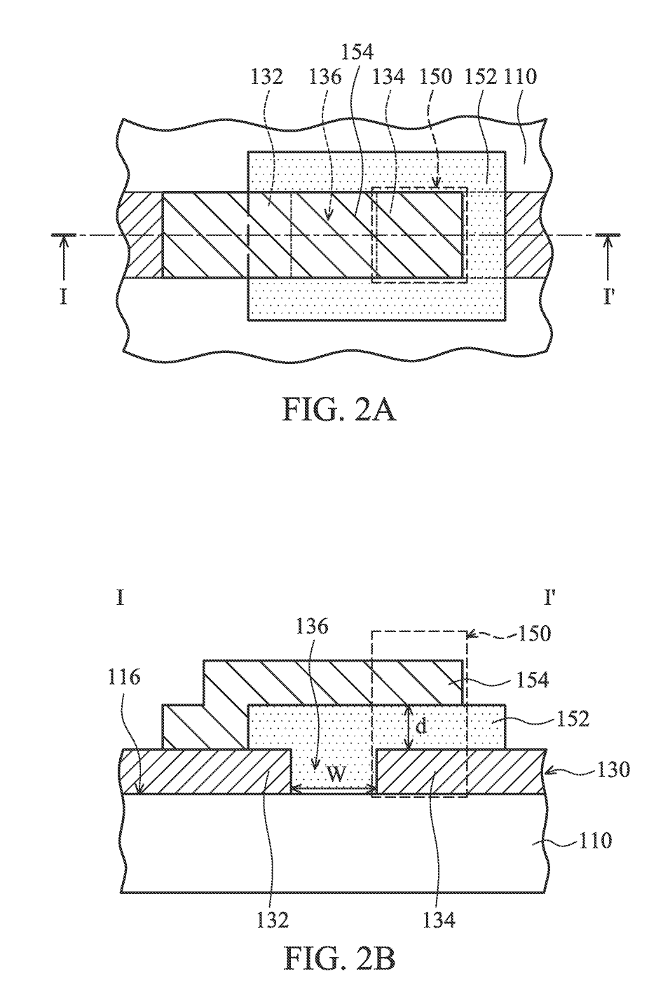

FIG. 2A is an enlarged view of the structure in the region A of FIG. 1. FIG. 2B is a cross-sectional view of the structure along sectional line I-I′ in FIG. 2A. Specifically, referring to FIGS. 1, 2A, and 2B, in the present embodiment, the ground ring 130 is positioned on a surface 116 of the substrate 110. In the present embodiment, the ground ring 130 has a first end portion 132 and a second end portion 134. The first end portion 132 and the second end portion 134 are separated from each other by a gap 136. An insulating layer 152 fills the gap 136 and covers a portion of the first end portion 132 and a portion of the second end portion 134. A conductive layer 154 is connected to the first end portion 132 and extends onto the insulating layer 152. The conductive layer 154 overlaps a portion of the second end portion 134 in a vertical projection direction. It should be noted that, in the present disclosure, the vertical projection direction means a direction perpendicular to the surface 116 of the substrate 110. Portions of the conductive layer 154, the insulating layer 152, and the second end portion 134 overlapping each other in the vertical projection direction form a capacitor device 150. The second end portion 134 of the ground ring 130 and the conductive layer 154 are two terminal electrodes of the capacitor device 150. The capacitor device 150 is electrically connected to the ground ring 130 through the conductive layer 154 and the second end portion 134. In one embodiment, the first end portion 132, the second end portion 134, and the insulating layer 152 sandwiched therebetween are a portion (or a sub-capacitor) of the capacitor device 150.

In one embodiment, the insulating layer 152 includes an organic insulating material or an inorganic insulating material. In one embodiment, the insulating layer 152 includes a polymer material. In one embodiment, the insulating layer 152 includes a photoresist material. In one embodiment, the insulating layer 152 has a dielectric constant of about 3 to about 4.

It should be noted that since the ground ring 130 of the present embodiment is electrically connected to the capacitor device 150, electrostatic charges, which are produced in the process or ordinarily exist in the atmospheric environment, are not only able to be stored in the ground ring 130, but also able to be stored in the capacitor device 150. Therefore, the damage to the touch electrode pattern 120 in the touch region 112 caused by the electrostatic charges is effectively prevented. Therefore, the touch panel 100 of the present embodiment is able to sustain a large electrostatic voltage (e.g., greater than 2 kV). The capacitor device 150 may effectively improve the electrostatic discharge protection of the touch panel 100 of the present embodiment.

Furthermore, in the present embodiment, the capacitance of the capacitor device 150 may be adjusted by adjusting an overlap area and a distance d between the conductive layer 154 and the second end portion 134, and materials of the insulating layer 152 according to actual requirements. In one embodiment, the touch panel 100 with the ground ring 130 and the capacitor device 150 is able to sustain electrostatic voltage ranging from 2 kV to 6 kV. In one embodiment, the overlap area between the conductive layer 154 and the second end portion 134 is greater than or equal to about 30000 μm2.

In one embodiment, the gap 136 has a width W ranging substantially from 4 μm to 10 μm. In one embodiment, the width W of the gap 136 ranges substantially from 4 μm to 5 μm. In one embodiment, the distance d between the conductive layer 154 and the second end portion 134 ranges substantially from 1 μm to 2 μm.

In one embodiment, the material of the conductive layer 154 is different from the material of the ground ring 130. In the present embodiment, the ground ring 130 includes a transparent conductive material, and the conductive layer 154 includes a metal material. The ground ring 130, the first touch electrodes 122, the connecting portions 122a, and the second touch electrodes 124 may be formed in the same process. The conductive layer 154 and the bridge portions 124a may be formed in the same process.

The materials of the ground ring 130 and the conductive layer 154 may be adjusted according to the sequence of the processes for forming the touch electrodes 122 and 124 and the bridge portions 124a. For example, in another embodiment (not shown), the bridge portions 124a are formed first, and the touch electrodes 122 and 124 are formed second. Therefore, the ground ring 130 and the bridge portions 124a are formed of the same material (e.g., metal), and the conductive layer 154 and the touch electrodes 122 and 124 are formed of the same material (e.g., a transparent conductive material). In one embodiment, the conductive layer 154 and the ground ring 130 are formed of the same material.

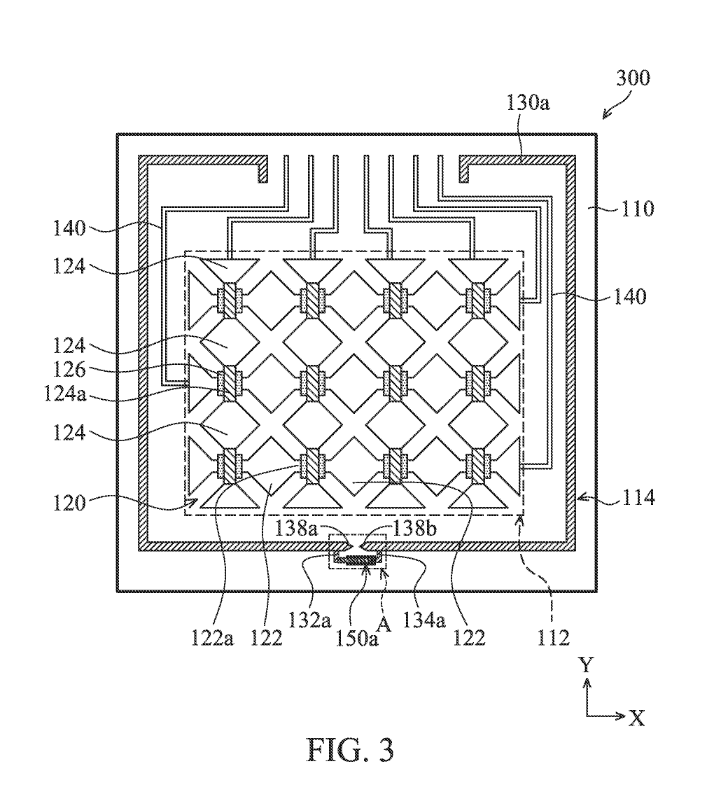

FIG. 3 is a top view of a touch panel of an embodiment of the present invention. It should be noted that, as shown in FIG. 3, the touch panel 300 of the present embodiment is similar to the touch panel 100 of FIG. 1, except that the ground ring 130a and the capacitor device 150a of the present embodiment are different from the ground ring 130 and the capacitor device 150 of the touch panel 100.

Specifically, in the present embodiment, the ground ring 130a has a first discharge tip 138a and a second discharge tip 138b opposite to the first discharge tip 138a. A gap 138c separates the first discharge tip 138a from the second discharge tip 138b. In one embodiment, the gap 138c has a width W1 ranging substantially from 10 μm to 20 μm.

When the first discharge tip 138a or the second discharge tip 138b accumulates enough static electricity that the voltage difference therebetween is greater than a threshold value, tip discharge occurs. A transfer of charge from the discharge tip with the accumulated static electricity (i.e., the high-voltage end) to the discharge tip without a static buildup (i.e., the low-voltage end) occurs. Thereafter, the low-voltage end may be grounded to remove the static electricity from the ground ring 130a.

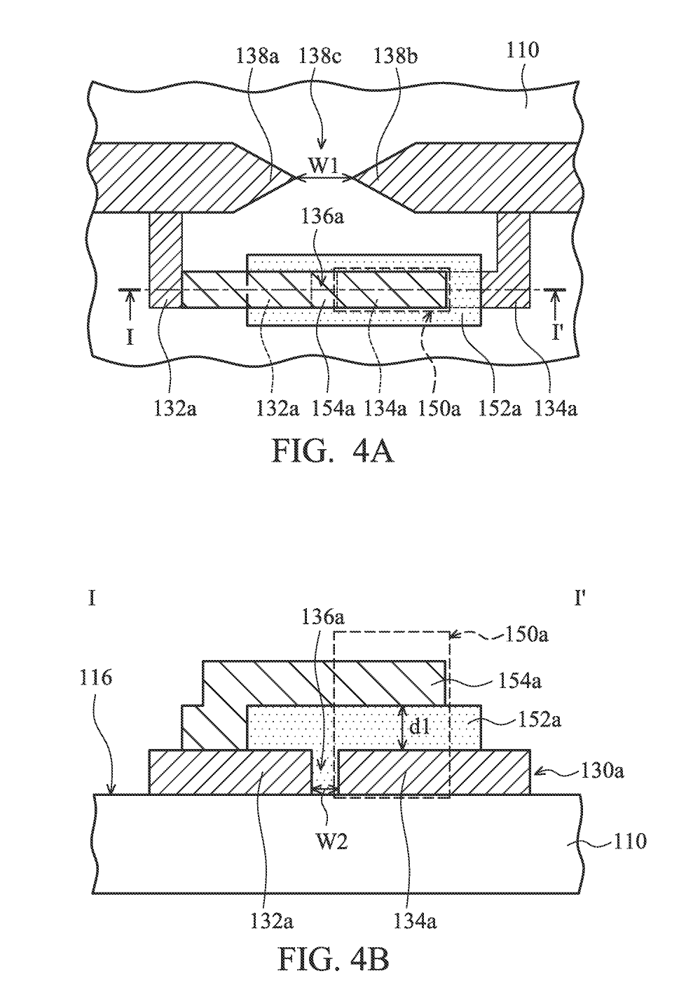

FIG. 4A is an enlarged view of the structure in the region A of FIG. 3. FIG. 4B is a cross-sectional view of the structure along sectional line I-I′ in FIG. 4A. Referring to FIGS. 3, 4A, 4B, in the present embodiment, the ground ring 130a has a first extension portion 132a and a second extension portion 134a. The first extension portion 132a extends from a side of the first discharge tip 138a. The second extension portion 134a extends from a side of the second discharge tip 138b. A gap 136a separates the first extension portion 132a from the second extension portion 134a.

An insulating layer 152a fills the gap 136a and partially covers the first extension portion 132a and the second extension portion 134a. A conductive layer 154a is connected to the first extension portion 132a and extends onto the insulating layer 152a. The conductive layer 154a partially overlaps the second extension portion 134a in a vertical projection direction. Portions of the conductive layer 154a, the insulating layer 152a, and the second extension portion 134a overlapped with each other in the vertical projection direction form a capacitor device 150a. The second extension portion 134a of the ground ring 130a and the conductive layer 154a are two terminal electrodes of the capacitor device 150a. The capacitor device 150a is electrically connected to the ground ring 130a through the conductive layer 154a and the second extension portion 134a. In one embodiment, the first extension portion 132a, the second extension portion 134a and the insulating layer 152a sandwiched therebetween are a portion (or a sub-capacitor) of the capacitor device 150a.

It should be noted that, since the ground ring 130a of the present embodiment is electrically connected to the capacitor device 150a, electrostatic charges, that are produced in the process or ordinarily exist in the atmospheric environment, are not only able to be stored in the ground ring 130a, but also able to be stored in the capacitor device 150a. Therefore, the touch panel 300 of the present embodiment is able to sustain a large electrostatic voltage (e.g., greater than 2 kV). The capacitor device 150a may effectively improve the electro-static discharge protection of the touch panel 300 of the present embodiment.

In one embodiment, the gap 136a has a width W2 ranging substantially from 4 μm to 10 μm. In one embodiment, the width W2 of the gap 136a ranges substantially from 4 μm to 5 μm. In one embodiment, the distance d1 between the conductive layer 154a and the second extension portion 134a ranges substantially from 1 μm to 2 μm. In one embodiment, the material of the conductive layer 154a is different from the material of the ground ring 130a. In one embodiment, the conductive layer 154a and the ground ring 130a are formed of the same material.

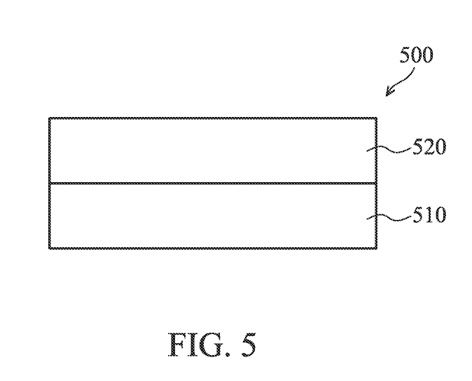

FIG. 5 is a cross-sectional view of a touch display device of an embodiment of the present invention. Referring to FIG. 5, a touch display device 500 of the present embodiment includes a display panel 510 and a touch panel 520. The display panel 510 is, for example, a liquid crystal display panel, an organic light emitting diode display panel, or another suitable display panel. The touch panel 520 is disposed on the display panel 510. The touch panel 520 may be the touch panel 100 of FIG. 1 or the touch panel 300 of FIG. 3.

As described above, since the ground ring of the present invention is electrically connected to the capacitor device, electrostatic charges, that are produced in the process or ordinarily exist in the atmospheric environment, are not only able to be stored in the ground ring, but also able to be stored in the capacitor device. Therefore, the touch panel of the present invention is able to sustain a large electrostatic voltage. The capacitor device may effectively improve the electro-static discharge protection of the touch panel of the present invention.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A touch panel, comprising:
a substrate having a touch region and a peripheral region surrounding the touch region;
a touch electrode pattern disposed in the touch region; and
a ground ring disposed in the peripheral region and surrounding the touch region, wherein the ground ring is electrically connected to a capacitor device.

2. The touch panel as claimed in claim 1, wherein at least one terminal electrode of the capacitor device is an end portion of the ground ring or an extension portion of the ground ring.

3. The touch panel as claimed in claim 1, wherein the ground ring comprises a first end portion and a second end portion, a gap separates the first end portion from the second end portion, an insulating layer covers the second end portion, a conductive layer is connected to the first end portion and extends onto the insulating layer, the conductive layer overlaps the second end portion, and the conductive layer, the insulating layer, and the second end portion form the capacitor device.

4. The touch panel as claimed in claim 3, wherein the material of the conductive layer is different from the material of the ground ring.

5. The touch panel as claimed in claim 3, wherein a distance between the conductive layer and the second end portion ranges substantially from 1 μm to 2 μm.

6. The touch panel as claimed in claim 1, wherein the ground ring comprises a first discharge tip and a second discharge tip opposite to the first discharge tip, and a first gap separates the first discharge tip from the second discharge tip.

7. The touch panel as claimed in claim 6, wherein the ground ring further comprises a first extension portion and a second extension portion, the first extension portion extends from a side of the first discharge tip, the second extension portion extends from a side of the second discharge tip, a second gap separates the first extension portion from the second extension portion, an insulating layer covers the second extension portion, a conductive layer is connected to the first extension portion and extends onto the insulating layer, the conductive layer overlaps the second extension portion, and the conductive layer, the insulating layer, and the second extension portion form the capacitor device.

8. The touch panel as claimed in claim 7, wherein a material of the conductive layer is different from a material of the ground ring.

9. The touch panel as claimed in claim 1, wherein the ground ring comprises a metal material or a transparent conductive material.

10. A touch display device, comprising:
a display panel; and
a touch panel disposed on the display panel, wherein the touch panel comprises:
a substrate having a touch region and a peripheral region surrounding the touch region;
a touch electrode pattern disposed in the touch region; and
a ground ring disposed in the peripheral region and surrounding the touch region, wherein the ground ring is electrically connected to a capacitor device.
